(19) United States
(12) Patent Application Publication
(10) Pub. No.: US 2026/0107219 A1
(43) Pub. Date: Apr. 16, 2026

(54) METHOD, DEVICE, AND MEDIUM FOR BINDING INFORMATION RECOVERY SERVICE

(71) Applicant: Verizon Patent and Licensing Inc., Basking Ridge, NJ (US)

(72) Inventors: Tallis Trevon Yates, IV, Prosper, TX (US); Lixia Yan, Basking Ridge, NJ (US); John Edward Morris, Fort Mill, SC (US); Nathen Allen Wheelbarger, Fort Worth, TX (US)

(21) Appl. No.: 18/915,767

(22) Filed: Oct. 15, 2024

(51) Int. Cl. H04W 48/18

(52) U.S. Cl. CPC H04W 48/18

(57) ABSTRACT

A method, a network device, and a non-transitory computer-readable storage medium are described in relation to an binding information recovery service. The binding information recovery service may enable a binding support device to recover previously created binding information that was subsequently lost or binding information that had never been created due to an error. The binding information recovery service may select candidate network devices to query for the binding information. Subsequent to recovery of the binding information, the binding information recovery service may provide requesting network devices the binding information.

### BACKGROUND

Development and design of networks present certain challenges from a network-side perspective and an end device perspective. For example, Next Generation (NG) wireless networks, such as Fifth Generation New Radio (5G NR) networks are being deployed and under development.

### BRIEF DESCRIPTION OF THE DRAWINGS

FIG. 1 is a diagram illustrating an exemplary environment in which an exemplary embodiment of a binding information recovery service may be implemented;

FIGS. 2A and 2B are diagrams illustrating an exemplary process of an exemplary embodiment of the binding information recovery service;

FIG. 3 is a diagram illustrating exemplary components of a device that may correspond to one or more of the devices illustrated and described herein; and

FIG. 4 is a flow diagram illustrating an exemplary process of an exemplary embodiment of the binding information recovery service.

### DETAILED DESCRIPTION

The following detailed description refers to the accompanying drawings. The same reference numbers in different drawings may identify the same or similar elements. Also, the following detailed description does not limit the invention.

In a 5G core network or another type of core network, a policy control function (PCF), a split PCF (e.g., a session management (SM)-PCF, an access and mobility management (AM)-PCF, a user equipment (UE)-PCF, etc.), or a similar type of policy control network device may provide various policies to another network device, network element, or (physical or virtual) network function (referred to herein as “network device”). For example, the PCF may provide packet data unit (PDU) session management control policies to a session management function (SMF), access and mobility-related policy control information to an access and mobility management function (AMF), and PDU session related policies to an end device (e.g., user equipment (UE)).

A binding support function (BSF) may assist the AMF and the SMF to obtain policies from the PCF. For example, an SM-PCF may register, update, and remove PDU session binding information in the BSF, and an AM-PCF may register, update, and remove PDU binding information in the BSF. Other types of network devices, such as an application function (AF), a network exposure function (NEF), or a call session control function (CSCF), or another type of network device or network function (NF) service consumer may request binding information from the BSF regarding an end device, a PDU session, or the like.

However, there are circumstances in which the binding information is not successfully created or may be lost subsequent to the creation of the binding information. According to such circumstances, a network device may be unable to obtain requested binding information and the BSF may be unable to recover or re-create the binding information. As a result, the establishment or the maintenance of a PDU session, a voice session, or another type of application service session (e.g., a multicast broadcast service (MBS) session, etc.) may be prevented. According to another example, a requesting network device may be unable to provide a network service (e.g., a service associated with a network data analytics function (NWDAF), a time sensitive communication and time synchronization function (TSCTSF), a direct discovery name management function (DDNMF), or the like) that would otherwise be provided based on the binding information. According to still other example, the setup of a dedicated bearer (e.g., an Internet Protocol (IP) Multimedia Subsystem (IMS) dedicated bearer for voice or video call, etc.) may be prevented, and/or other types of failures or degradations that may negatively impact the end device, the network, or both, may occur.

According to exemplary embodiments, a binding information recovery service is described. According to an exemplary embodiment, a BSF or a network device that provides a similar function as the BSF (e.g., a session binding function (SBF), a future generation BSF, a binding support device, etc.) may include logic that provides an exemplary embodiment of the binding information recovery service, as described herein.

According to an exemplary embodiment, the binding information recovery service may include determining that the requested binding information is not available. For example, in response to a binding request for binding information, the BSF may perform a lookup or search for requested binding information. Based on the result of the lookup or the search, the BSF may determine that the requested binding information does not exist.

According to an exemplary embodiment, the binding information recovery service may perform a recovery procedure. According to exemplary embodiment, the binding information recovery service may include selecting one or multiple PCFs, split PCFs, and/or the like which to query for the binding information. According to an exemplary embodiment, the binding information recovery service may generate and transmit a request for (PCF) binding information. The request may include an address of an end device of relevance (e.g., an IPv4, an IPv6, or a media access control (MAC) address of an end device/UE) and data indicating a request for binding information. The request may include other data, as described herein. According to some exemplary embodiments, the binding information recovery service may broadcast the request to multiple PCFs, split PCFs, or the like, as described herein.

According to an exemplary embodiment, the binding information recovery service may read and analyze the response from each PCF, split PCF, or the like, and may determine if the response includes the (PCF) binding information. When the response includes the PCF binding information, the binding information recovery service may recreate the binding information.

According to an exemplary embodiment, the binding information recovery service may generate and transmit a response, which includes the requested binding information, to the requesting network device.

According to an exemplary embodiment, the binding information recovery service may generate and transmit a reply to the PCF, split PCF, or the like, which provided the (PCF) binding information. The reply may include data containing a representation of the re-created binding information and a uniform resource indicator (URI) or another type of address indicator of the re-created binding information.

In view of the foregoing, the binding information recovery service may minimize retrieval failures of binding information. Additionally, the binding information recovery service may improve session failures, bearer setups, minimize network service failures, and improve overall performance in the network.

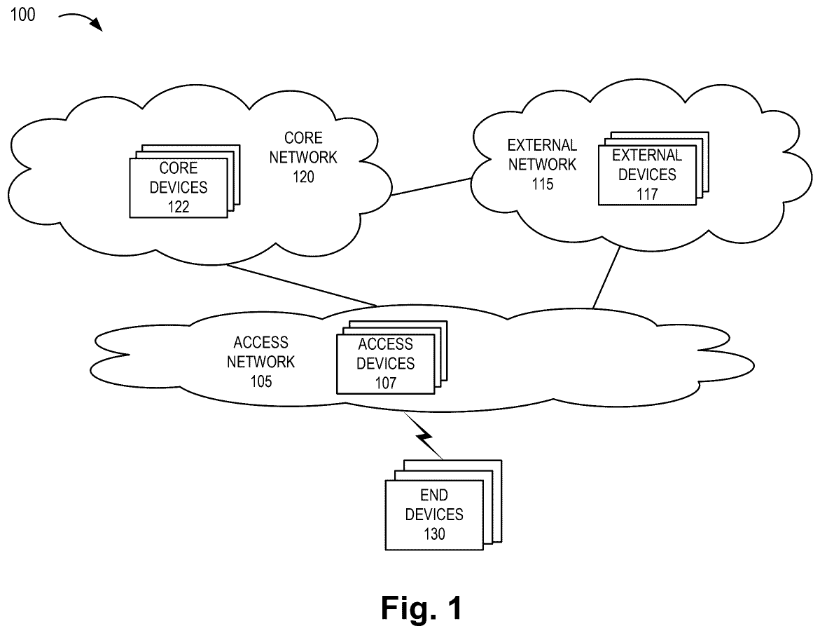

FIG. 1 is a diagram illustrating an exemplary environment 100 in which an exemplary embodiment of binding information recovery service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, network slice, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the binding information recovery service may use at least one of these planes of communication. Additionally, an interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), and the like) or a new interface of the network device may be provided in order to support the communication (e.g., transmission and reception of messages, an information element (IE), an attribute value pair (AVP), an object, a header, a parameter, or another form of a data instance) between network devices and the binding information recovery service logic of the network device. According to various exemplary implementations, the interface of the network device may be a service-based interface, a reference point-based interface, an Open Radio Access Network (O-RAN) interface, a 5G interface, another generation of interface (e.g., 5.5G, Sixth Generation (6G), Seventh Generation (7G), etc.), or some other type of network interface.

Access network 105 may include one or multiple networks of one or multiple types and technologies. For example, access network 105 may be implemented to include a Fifth Generation (5G) RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a Fourth Generation (4G) or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a next generation Node B (gNB), an evolved LTE (eLTE) evolved Node B (eNB), an eNB, a radio network controller (RNC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi device, a WiMax device, a hotspot device, etc.) that provides a wireless access service, or another type of network device that provides a transport service (e.g., routing and forwarding), such as a router, a switch, or another type of layer 3 (e.g., network layer of the Open Systems Interconnection (OSI) model) network device.

External network 115 may include one or multiple networks of one or multiple types and technologies that provides an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a MEC network, a fog network, the Internet, a packet data network (PDN), a service provider network, the World Wide Web (WWW), an IMS network, a Rich Communication Service (RCS) network, an SD network, a virtual network, a packet-switched network, a data center, or other type of network that may provide access to and may host an end device application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), IoTs (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of a Long Term Evolution (LTE) network, an LTE-Advanced (LTE-A) network, and/or an LTE-A Pro network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, a SMF, a unified data management (UDM) device, a unified data repository (UDR), an authentication server function (AUSF), a network slice selection function (NSSF), a network repository function (NRF), a PCF, a BSF, an NWDAF, a NEF, a service capability exposure function (SCEF), a lifecycle management (LCM) device, an AF, a mobility management entity (MME), a packet gateway (PGW), an enhanced packet data gateway (ePDG), a serving gateway (SGW), an application function (AF), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), a DDNMF, a TSCTSF, and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the binding information recovery service. For example, the BSF may include logic of the binding information recovery service, as described herein. Additionally, for example, a PCF, a split PCF, or a similar functioning policy control device may include logic of the binding information recovery service, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, a wearable device (e.g., a watch, glasses, etc.), a computer, a gaming device, a music device, an Internet of Things (IoT) device, a drone, a smart device, or other type of wireless device (e.g., other type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

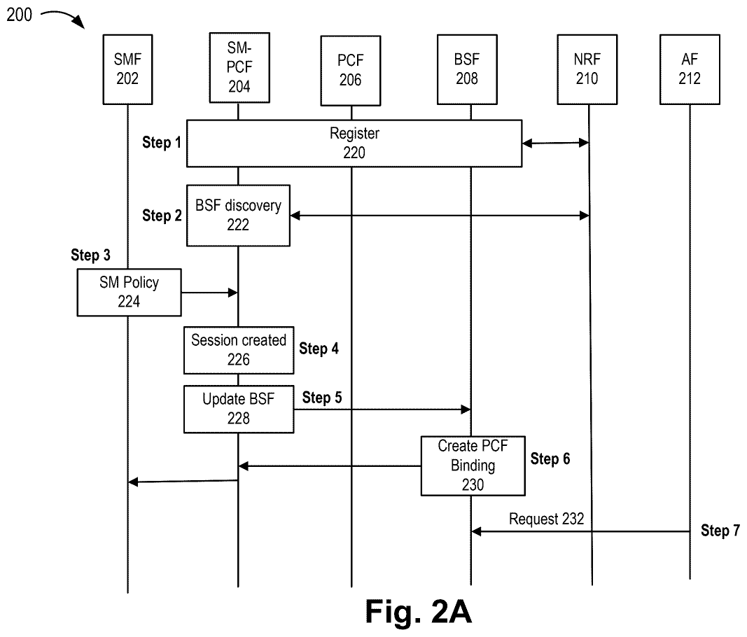

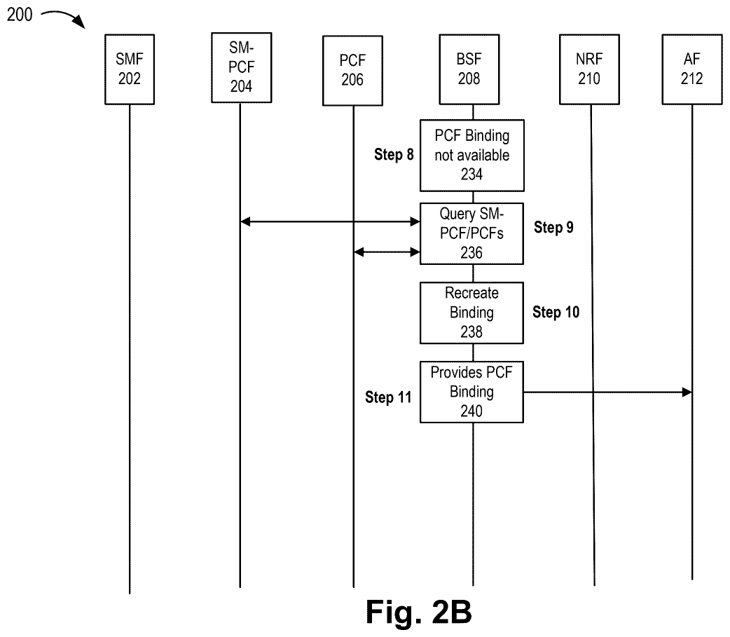

FIGS. 2A and 2B are diagrams illustrating an exemplary process 200 of an exemplary embodiment of the binding information recovery service according to an exemplary scenario. As illustrated, process 200 may be implemented in an environment that includes core devices 122, such as an SMF 202, an SM-PCF 204, a PCF 206, a BSF 208, an NRF 210, and an AF 212.

Similar to that described in relation to FIG. 1, according to other exemplary embodiments, the environment may include fewer, additional, and/or different types of core devices 122, not specifically illustrated and described in FIGS. 2A and 2B. For example, BSF 208 may alternatively be implemented as a Session Binding Function (SBF)+BSF, an SBF, a future generation BSF, or another type of binding support device that may provide similar functions and services. Additionally, or alternatively, SMF 204 may be implemented as a PGW-C+SMF, for example. Additionally, or alternatively, the environment may include only integrated PCFs, only split PCFs, and/or other types of policy control devices (e.g., UE-PCF, AM-PCF, a PCRF+PCF, etc.). According to some exemplary embodiments, the environment may include multiple instances of a network device. For example, there may be multiple PCFs 206, multiple SM-PCFs 205, and so forth.

Additionally, or alternatively, the environment may include core device 122 (other than AF 212), such as a NEF or another type of NF service consumer of the BSF, which may transmit a binding request to BSF 208, as described herein. Additionally, or alternatively, the environment may include external device 117. For example, a proxy-CSCF (P-CSCF) or an AF of external network 115 may transmit a binding request to BSF 208, as described herein.

The messages illustrated and described are exemplary. Additionally, process 200 may include additional or different messages communicated between core devices 122 not specifically described and illustrated.

SMF 202, SM-PCF 204, PCF 206, BSF 208, NRF 210, and AF 212 may each provide a function and/or a service in accordance with a network standard (e.g., 3GPP, 3GPP2, ITU, ETSI, GSMA, and/or the like) and/or of a proprietary nature. For example, SMF 202 may provide session management, Internet Protocol (IP) address allocation and management, selection and control of user plane (UP) function, configuration of traffic steering, control of policy enforcement and QoS, among other functions.

SM-PCF 204 may provide SM policies/rules to control plane network devices, make SM policy decisions based on subscription information associated with end device 130, among other functions.

PCF 206 may provide policies/rules to control plane network devices, make policy decisions based on subscription information, among other functions. BSF 208 may create binding information pertaining to a session, support management and discovery services, such as allowing network devices to register, update and remove binding information, and allow network devices to discover the binding information, among other functions.

NRF 210 may maintain a repository of network devices in a core network, support dynamic registration and deregistration of the network devices, facilitate service discovery, enable dynamic network function selection, among other functions.

AF 212 may provide application influence on traffic routing, interact with the policy framework, provide service or application-related information to NF service consumers, among other functions.

Additionally, for example, SM-PCF 204, PCF 206, and BSF 208 may each include logic of an exemplary embodiment of a binding information recovery service, as described herein.

For purposes of description and illustration only, process 200 is described in relation to steps. The order of the steps may be different according to other embodiments of process 200, and non-dependent steps may be performed concurrently, for example.

Referring to FIG. 2A, according to an exemplary scenario, in step (1) of process 200, assume that SM-PCF 204, PCF 206, and BSF 208 each registers 220 with NRF 210. For example, the registration procedure may include SM-PCF 204, PCF 206, and BSF 208 each transmitting a message that includes their URI, a network device profile, and a network device identifier to NRF 210. Upon successful completion of registering the network device, NRF 210 may transmit a message, which includes data indicating successful registration, to the network device (e.g., SM-PCF 204, PCF 206, BSF 208).

In step (2), SM-PCF 204 may perform a BSF discovery procedure 222. For example, SM-PCF 204 may transmit a request, which includes query parameters, for an NF service (e.g., BSF service). NRF 210 may perform a lookup or search based on the query parameter, and generate and transmit a response, which includes a search result that may satisfy the search filter criteria (e.g., BSF 208).

As part of a PDU session establishment procedure, an AMF (not illustrated) may select SMF 202, and may generate and transmit an HTTP POST message, which includes a request to create an SM context (e.g., SM Context Create), to SMF 202. In step (3), SMF 202 may select a PCF (e.g., SM-PCF 204), and generate and transmit an HTTP POST message, which includes a request to create an SM policy association 224 with the SM-PCF 204 and, in step (4), SM-PCF 204 may create session information 226.

According to this exemplary scenario, in step (5), SM-PCF 204 may update 228 BSF 208 regarding the PDU session with binding information. For example, SM-PCF 204 may generate an HTTP POST message, which includes binding information. The binding information may include an address of end device 130, an SM-PCF address, identifier (ID), and/or PCF set ID, and potentially other types of information (e.g., a data network name (DNN), Single-Network Slice Selection Assistance Information (S-NSSAI), Subscription Permanent Identifier (SUPI) of end device 130, a Generic Public Subscription Identifier (GPSI), etc.).

In step (6), BSF 208 may create 230 the binding information, and provide a response to SM-PCF 204. For example, an HTTP 201 Created message may include a representation of the created binding information and a URI of the created binding information. SM-PCF 204 may also generate and transmit an SM policy for the PDU session (e.g., SM Policy Context), to SMF 202.

According to other exemplary scenarios (not illustrated in FIG. 2A), SM-PCF 204 may not successfully update BSF 208. For example, SM-PCF 204 may not successfully transmit the update message (e.g., due to internally operational issues) or may successfully transmit the update message but a transport issue occurs that prevents the update message being received and processed by BSF 208. According to other exemplary scenarios, BSF 208 may receive the update message, but has an operational issue that prevents the creation of the binding information, as described in relation to step (6). According to yet other exemplary scenarios, transport issues may cause replication issues on BSF 208 or corruption of the storage of the binding information (e.g., database corruption). According to still other exemplary scenarios, the binding information may be removed due to exceeding a time-to-live (TTL) value (e.g., aging) or a request for deleting the binding information may be processed before the request for the binding information, as described in step (7).

While this description provides examples of issues that may occur that may cause or relate to binding information not created, binding information created but subsequently deleted, or the like, such examples are not exhaustive. However, regardless of the reason for a requested binding information not being available, as further described in relation to steps (7) and (8) of FIGS. 2A and 2B, the binding information recovery service may enable BSF 208 to re-create the binding information and provide a response, which includes the requested binding information, to the requesting network device or NF service consumer.

In step (7), BSF 208 may receive a request 232 from AF 212. For example, request 232 may be implemented as an HTTP GET message that includes an address of end device 130. The HTTP GET message may include other query parameters pertaining to end device 130 and/or the PDU session (e.g., SUPI, GPSI, DNN, S-NSSAI, Mobile Station International Subscriber Directory Number (MSISDN), ID of an MBS session, or the like), a resource URI, etc.

According to other exemplary scenarios, the requesting network device or NF service consumer may be a different type of network device, such as a NEF, an NWDAF, a TSCTSF, an MBSF, a DDNMF, or the like. Additionally, or alternatively, the request for binding information may relate to discovery of a selected PCF for a PDU session, an MBS session, or UE.

Referring to FIG. 2B, in step (8), in response to receiving the request for binding information, BSF 208 may perform a lookup. For example, BSF 208 may compare the query parameters included in request 232 to the binding information stored by BSF 208. Based on the result of the comparison, BSF 208 may determine that the binding information is not available or not found 234. In contrast to existing methods, in which BSF 208 may generate and transmit an HTTP 404 (Not Found) message to AF 212, an IP-CAN_SESSION_NOT_AVAILABLE message to a CSCF (not illustrated), or another suitable message to the requesting NF service consumer, according to an exemplary embodiment of the binding information recovery service, BSF 208 may perform the recovery procedure, as described herein. For example, in step (9), BSF 208 may query 236 SM-PCFs and/or PCFs for the requested binding information.

According to this exemplary scenario, BSF 208 may query for the SM-PCF of the PDU session, which may be supported by an SM-PCF or an integrated PCF. According to other exemplary scenarios, depending on the request for binding information (e.g., binding information for a PDU session, an MBS session, a UE, PCF binding information, AM-PCF binding information, SM-PCF binding information, UE-PCF binding information, etc.), BSF 208 may query PCF(s), query SM and/or other types of split PCF(s) (e.g., AM-PCF, UE-PCF, etc.) and/or another type of network device or NF service consumer.

According to an exemplary embodiment of the recovery procedure, BSF 208 may identify and select candidate network devices from which to query or request the binding information. For example, BSF 208 may determine the type of binding information. Additionally, BSF 208 may identify candidate network devices to which BSF 208 may be connected and their associated service. Based on this information, BSF 208 may select the candidate network devices to query. According to this exemplary scenario, BSF 208 may query SM-PCF 204 and PCF 206. The query or request may include an end device address of end device 130 and other types of query parameters, which may have been included in request 232. The query or request may also include data requesting for binding information. According to some exemplary embodiments, BSF 208 may broadcast the request or query message to all candidate network devices. According to other exemplary embodiments, BSF 208 may multicast or unicast the request or query message.

In response, each SM-PCF 204 and PCF 206 may perform a lookup or search of binding information, and provide a response. For example, the response may indicate no binding information was found or may include binding information.

According to this exemplary scenario, assume that BSF 208 receives the binding information from SM-PCF 204, and in step (10), BSF 208 re-creates 238 the binding information. In step (11), BSF 208 generates and transmits a response, which includes the requested binding information 240, to AF 212.

FIGS. 2A and 2B are diagrams illustrating an exemplary process of an exemplary embodiment of the binding information recovery service. According to other exemplary embodiments and scenarios, the process may include additional operations, fewer operations, and/or different operations. For example, in response to the re-creation of the binding information, BSF 208 may transmit a response to SM-PCF 204 (e.g., from which the binding information was received). For example, response may be implemented as an HTTP 201 (Created) message that includes a representation of the binding information and its URI. SM-PCF 204 may update its context or binding information.

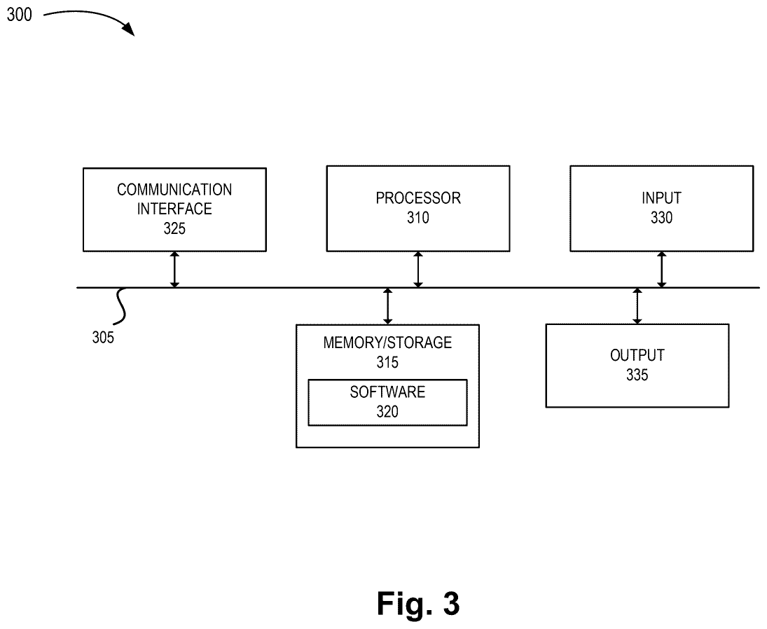

FIG. 3 is a diagram illustrating exemplary components of a device 300 that may be included in one or more of the devices described herein. For example, device 300 may correspond to access device 107, external device 117, core device 122, end device 130, SMF 202, SM-PCF 204, PCF 206, BSF 208, NRF 210, AF 212, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320).

Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 315 may store data, software, and/or instructions related to the operation of device 300.

Software 320 includes an application or a program that provides a function and/or a process. As an example, with reference to BSF 208, software 320 may include an application that, when executed by processor 310, provides a function and/or a process of binding information recovery service, as described herein. Additionally, with reference to SM-PCF 204 and PCF 206, software 320 may include an application that, when executed by processor 310, provides a function and/or a process of binding information recovery service, as described herein. Software 320 may also include firmware, middleware, microcode, hardware description language (HDL), and/or other form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function or a process described herein. Alternatively, for example, according to other implementations, device 300 performs a function or a process described herein based on the execution of hardware (processor 310, etc.).

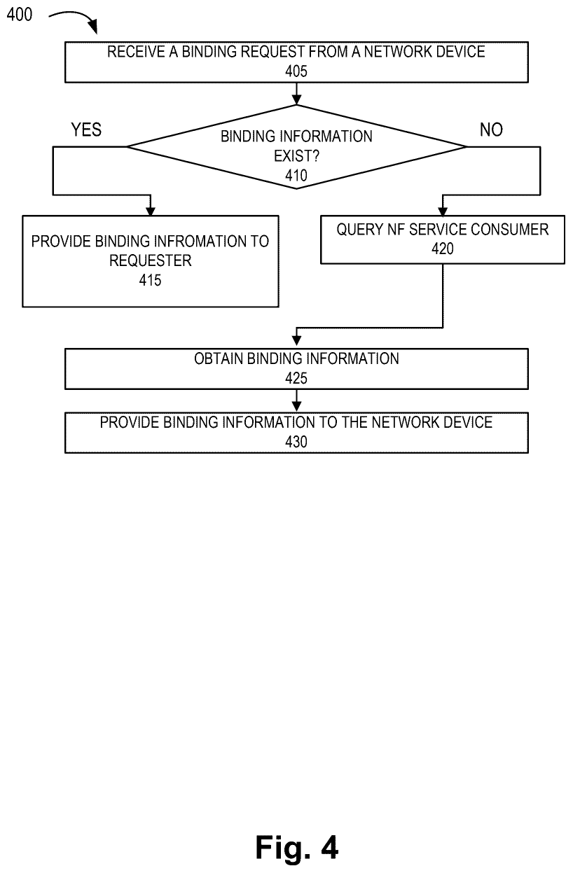

FIG. 4 is a flow diagram illustrating an exemplary process 400 of an exemplary embodiment of the binding information recovery service. According to an exemplary embodiment, a BSF (e.g., BSF 208) may perform a step of process 400. According to an exemplary implementation, processor 310 executes software 320 to perform a step of process 400, as described herein. Alternatively, a step may be performed by execution of only hardware.

In block 405, a BSF may receive a binding request from a network device. For example, BSF 208 may receive a binding request from an AF, a NEF, a NWDAF, a P-CSCF, or other type of NF service consumer, as described herein.

In block 410, the BSF may determine whether the binding information exists. For example, the BSF may perform a lookup or search for the requested binding information based on a query parameter included in the binding request, as described herein.

When the BSF determines that the binding information exists (block 410—YES), the BSF may provide the binding information to the requester (block 415). When the BSF determines that the binding information does not exist (block 410—NO), the BSF may query an NF service consumer (block 420). For example, the BSF may determine the type of binding information, and identify and select candidate network devices to query, as described herein.

In block 425, the BSF may obtain the binding information. For example, based on response to the query, the BSF may obtain the binding information and re-create the binding information at the BSF, as described herein.

In block 430, the BSF may provide the binding information to the network device. For example, the BSF may generate and transmit a binding response, which includes the requested binding information, to the AF, the NEF, the NWDAF, the P-CSCF, or other type of NF service consumer, as described herein.

FIG. 4 illustrates an exemplary process of the binding information recovery service, according to other exemplary embodiments, the binding information recovery service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a binding support device from a first network device, a first request for binding information;
determining, by the binding support device, that the binding information does not exist;
transmitting, by the binding support device to a candidate network device, a second request for the binding information;
receiving, by the binding support device from the candidate network device, a response to the second request that includes the binding information; and
transmitting, by the binding support device to the first network device, the binding information.

2. The method of claim 1, wherein the candidate network device is a policy control function (PCF) or a split PCF.

3. The method of claim 1, further comprising:
generating, by the binding support device, the second request based on one or more query parameters included in the first request.

4. The method of claim 1, further comprising:
determining, by the binding support device, a type of the binding information; and
selecting, by the binding support device based on the determining of the type, the candidate network device.

5. The method of claim 1, wherein the candidate network device includes multiple candidate network devices, and the transmitting of the second request further comprising:
broadcasting, by the binding support device to the candidate network devices, the second request.

6. The method of claim 1, further comprising:
storing, by the binding support device prior to receiving the first request, the binding information.

7. The method of claim 6, further comprising:
re-creating, by the binding support device based on the response, the binding information.

8. The method of claim 1, wherein the binding support device is a binding support function (BSF) of a Fifth Generation (5G) core network.

9. A network device comprising:
a processor that is configured to:
receive, from a first network device, a first request for binding information, wherein the network device is a binding support device;
determine that the binding information does not exist;
transmit to a candidate network device, a second request for the binding information;
receive from the candidate network device, a response to the second request that includes the binding information; and
transmit to the first network device, the binding information.

10. The network device of claim 9, wherein the candidate network device is a policy control function (PCF) or a split PCF.

11. The network device of claim 9, wherein the processor is further configured to:
generate the second request based on one or more query parameters included in the first request.

12. The network device of claim 9, wherein the candidate network device includes multiple candidate network devices, and wherein, when transmitting the second request, the processor is further configured to:
broadcast to the candidate network devices, the second request.

13. The network device of claim 9, wherein the processor is further configured to:
determine a type of the binding information; and
select, based on the type of the binding information, the candidate network device.

14. The network device of claim 9, wherein the processor is further configured to:
store, prior to receiving the first request, the binding information.

15. The network device of claim 14, wherein the processor is further configured to:
re-create, based on the response, the binding information.

16. The network device of claim 9, wherein the binding support device is a binding support function (BSF) of a Fifth Generation (5G) core network.

17. A non-transitory computer-readable storage medium storing instructions executable by a processor of a binding support device, wherein the instructions are configured to:
receive, from a first network device, a first request for binding information;
determine that the binding information does not exist;
transmit to a candidate network device, a second request for the binding information;
receive from the candidate network device, a response to the second request that includes the binding information; and
transmit to the first network device, the binding information.

18. The non-transitory computer-readable storage medium of claim 17, wherein the instructions comprise further instructions configured to:
store, prior to receiving the first request, the binding information.

19. The non-transitory computer-readable storage medium of claim 17, wherein the instructions comprise further instructions configured to:
determine a type of the binding information; and
select, based on the type of the binding information, the candidate network device.

20. The non-transitory computer-readable storage medium of claim 17, wherein the instructions comprise further instructions configured to:
generate the second request based on one or more query parameters included in the first request.
